(19) United States
(12) Patent Application Publication
(10) Pub. No.: US 2023/0301866 A1
(43) Pub. Date: Sep. 28, 2023

(54) Anti-Pinch Massage Device And Massage Head

(71) Applicant: SEB S.A., Ecully (FR)

(72) Inventors: Yohan Dassonville, Dardilly (FR); Vivien Marzin, Verze (FR); Fabien Normand, Estrablin (FR); Ambroise De La Chapelle, Saint-Genis-Les-Ollieres (FR)

(73) Assignee: SEB S.A., Ecully (FR)

(21) Appl. No.: 18/021,133

(22) PCT Filed: Aug. 10, 2021
(86) PCT No.: PCT/EP2021/072316

§ 371 Date: Feb. 13, 2023

(30) Foreign Application Priority Data
Aug. 14, 2020 (FR) FR2008509

(51) Int. Cl. A61H 15/00

(52) U.S. Cl. CPC A61H 15/0085; A61H 2015/0007; A61H 2201/1215; A61H 2205/022

(57) ABSTRACT

The invention relates to a massage head for a mechanical skin massage device with a gripping area and with which said massage head is intended to be connected, the latter comprising:
a working head, comprising massage means that each have a working surface for massaging the skin, each massage means being rotatable around a respective secondary rotation axis,
an actuating element for rotating said head around a primary rotation axis,
said working head comprising an outer surface from which each massage means emerges, each rising, from said outer surface, to a respective massage height comprised between 5 mm and 9 mm.

Mechanical skin massage devices and accessories.

The present invention relates to the general technical field of skin care devices, for example for home use, and more particularly to the field of massage devices designed to mechanically massage the skin, particularly the skin of the face.

The invention relates more specifically to a massage head for a mechanical skin massage device, said device comprising a main body forming a manual gripping area and to which said massage head is intended to be connected, the massage head comprising at least one working head, comprising massage means that each have a working surface intended to come into contact with the skin to massage it.

The present invention further relates to a mechanical skin massage device comprising such a massage head.

There is already a known massage device, which comprises a handle and a massage head, and which is designed to mechanically massage a user's skin by applying the massage head to the skin. This known massage head comprises a rotary part with several protruding studs intended to be applied to the skin to knead it. When the rotating part of its massage head is rotated around an axis, the studs, in contact with a portion of skin, rotate around that axis to lightly drag and distort that portion of skin.

This known massage device, while generally satisfactory, has some disadvantages. Thus, in the current known configuration of the massage device and of the massage head, during the aforementioned rotation, the skin sometimes gets abnormally trapped between various constituent elements of the massage device, and more particularly of the massage head, especially between the studs of the massage head. This results in an unpleasant or even painful pinching of the skin and therefore an inconvenience for the user of this device. The risk of such pinching is particularly high on certain areas of the body, particularly the face, where the skin is usually relatively supple, thin and sensitive. Moreover, this known massage device can be improved in terms of the effectiveness of the massage it provides.

The purposes of the invention are therefore to provide a response to the aforementioned needs and problems, and to provide in particular a new massage head that is particularly safe and pleasant to use, while offering excellent massage efficiency.

Another purpose of the invention is to provide a new massage head with a minimal size.

Another purpose of the invention is to provide a new massage head that can massage any type of skin under comfortable conditions of use.

Another purpose of the invention is to provide a new massage head that is particularly robust and reliable.

Another purpose of the invention is to provide a new massage head that can massage a user's skin under optimal safety conditions.

Another purpose of the invention is to provide a new massage head with a particularly simple construction and which is relatively easy and cost-effective to manufacture.

Another purpose of the invention is to provide a new massage head with a design that makes its maintenance particularly easy, fast, inexpensive, and minimal.

Another purpose of the invention is to provide a new massage head with a design that ensures excellent durability.

Another purpose of the invention is to provide a new massage head with optimized hygiene.

Another purpose of the invention is to provide a new massage device that can effectively and painlessly massage any type of skin, in different areas of the face, in a suitable manner for any person.

Another purpose of the invention is to provide a new massage device that is particularly safe and pleasant to use, while offering excellent massage efficiency.

The purposes of the invention are achieved by means of a massage head for a mechanical skin massage device, said device comprising a main body forming a manual gripping area and to which said massage head is intended to be connected, the massage head comprising at least:
a working head, comprising massage means that each have a working surface intended to come into contact with the skin to massage it, the working head being configured such that each massage means can be rotated around a respective secondary rotation axis, and
an actuating element designed and configured to rotate said working head around a primary rotation axis, said working head further comprising an outer surface from which each massage means emerges, each massage means rising, from said outer surface, to a respective massage height comprised between 5 mm and 9 mm.

The purposes of the invention are achieved by means of a mechanical skin massage device, comprising a main body forming a manual gripping area and a massage head intended to be connected to the main body, the massage head corresponding to the one described above.

Other features and advantages of the invention will become apparent and more detailed on reading the following description, with reference to the attached drawings, which are provided only as illustrative and non-limitative examples, in which:

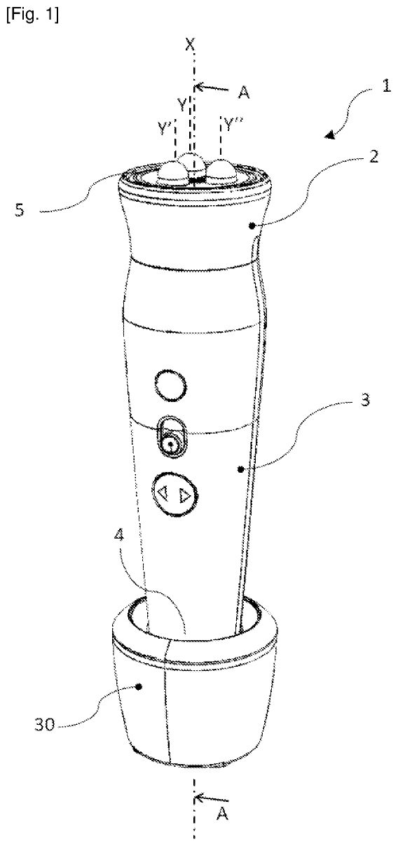

FIG. 1 illustrates, in a lateral perspective view, an embodiment of a massage device according to the invention, the device comprising a massage head also according to the invention;

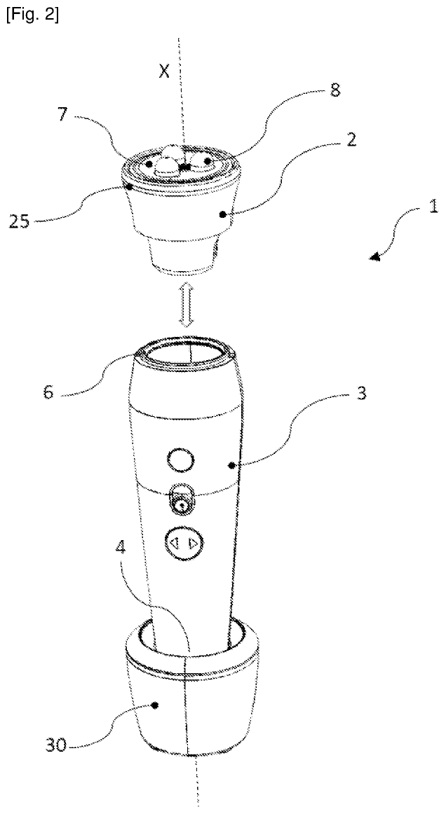

FIG. 2 illustrates, in a lateral perspective view, the device in FIG. 1, with the removable massage head detached from the main body;

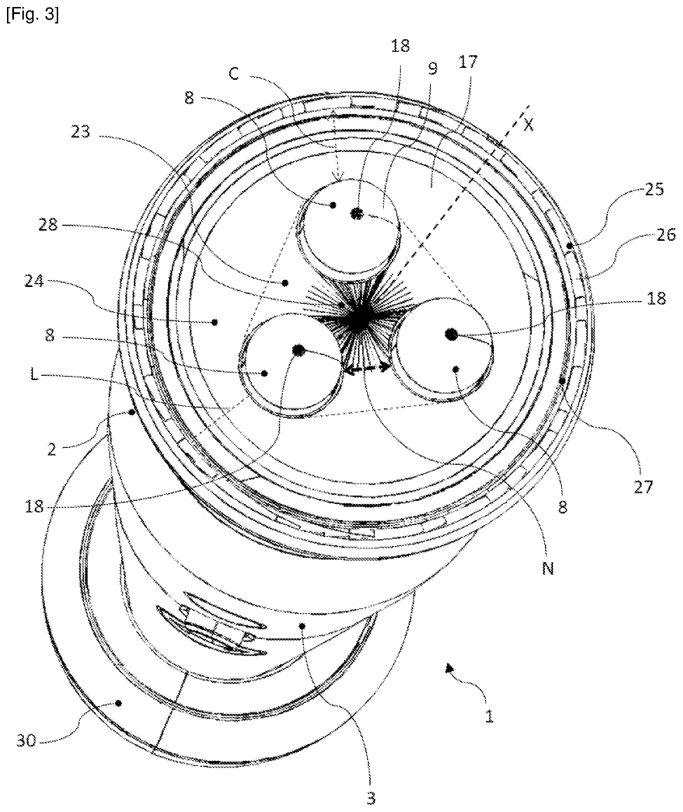

FIG. 3 illustrates, in a top perspective view, the device in FIG. 1;

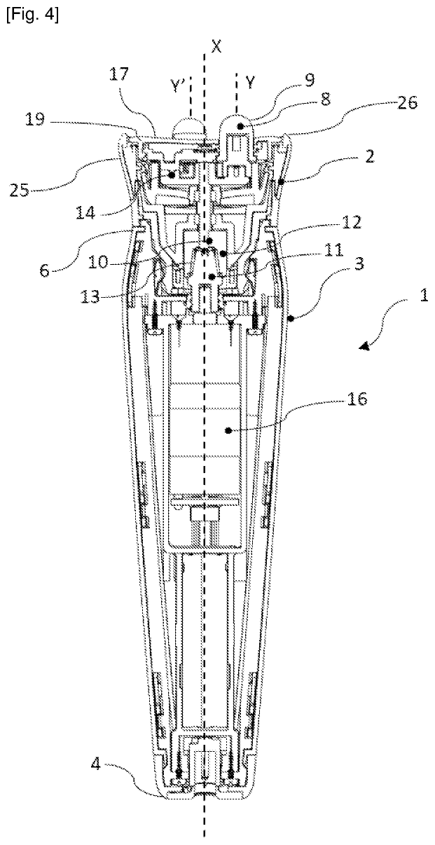

FIG. 4 illustrates the device in FIG. 1 in a sectional view A-A;

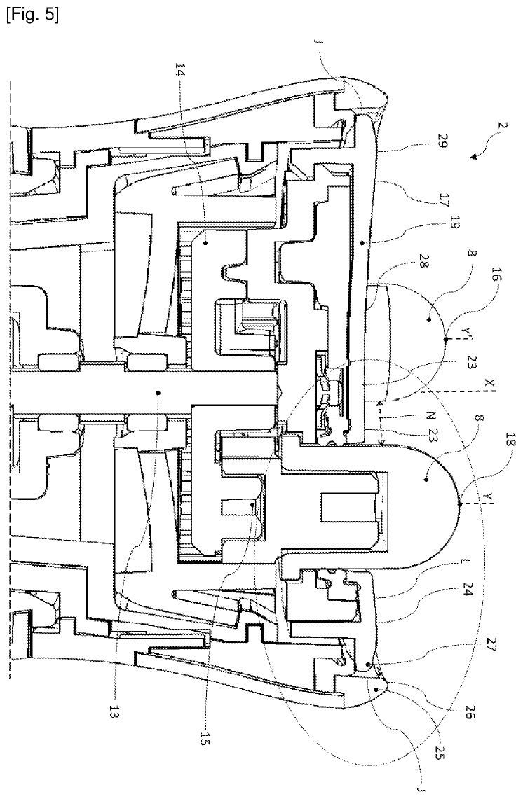

FIG. 5 illustrates, in a partial sectional view, a design detail of the massage head in FIG. 4;

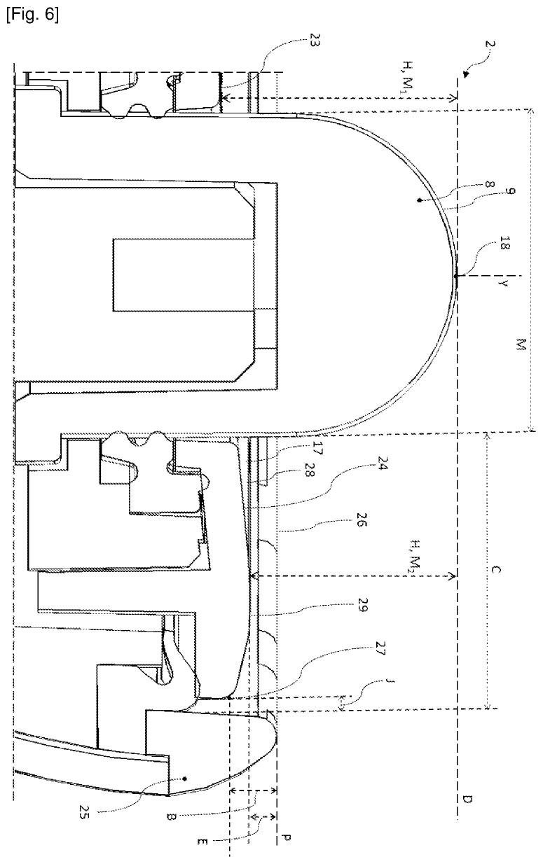

FIG. 6 illustrates, in an orthographic projection view, a design detail of a portion of the massage head surrounded by the dotted line in FIG. 5;

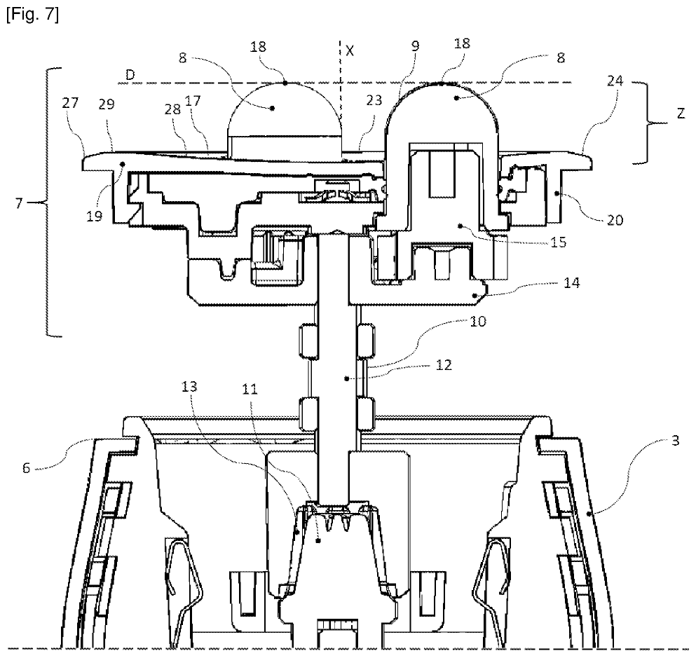

FIG. 7 illustrates, in an orthographic projection view, a design detail of the massage device in FIG. 4. Some elements of the head have been omitted or made transparent so as to highlight certain design features of the massage head and to specifically reveal its working head;

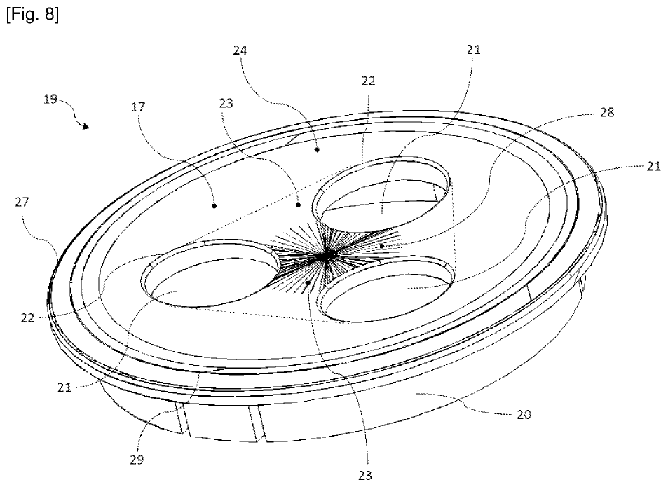

FIG. 8 illustrates, in a perspective view, a plate, which comprises the working head of the massage head in FIG. 1;

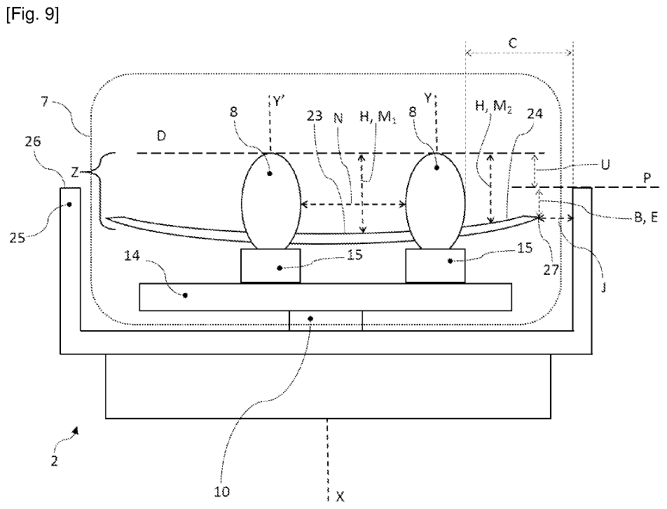

FIG. 9 schematically illustrates a simplified sectional view of a massage head according to the invention.

The invention relates, according to a first aspect, to a massage head 2 for a mechanical skin massage device 1, said device 1 comprising a main body 3 forming a manual gripping area and to which said massage head 2 is intended to be connected. Thus, in other words, the massage head 2 is advantageously designed to form the “active” part of the massage device 1, that is, to be a portion of the massage device intended to perform the mechanical massage action on the skin. The massage head 2 is therefore preferentially designed to provide (when attached to said main body 3 and activated) the mechanical skin massage and is preferably not designed to perform another type of action on the skin; for example, it is advantageously not designed to perform a skin massage by ultrasonic vibration. The term “mechanical massage” advantageously refers to any massage provided by rotary massage elements, such as the massage means 8 described below.

The invention further relates, according to a second aspect, to a mechanical skin massage device 1, comprising a main body 3 forming a manual gripping area and a massage head 2 intended to be connected to said main body 3, the massage head 2 corresponding to the first aspect of the invention, meaning as described in this description. Thus, this description relating to the massage head 2 is also valid for the massage device 1, and conversely this description relating to the massage device 1 is also valid for the massage head 2.

In particular, the massage device 1 according to the invention is designed to be gripped and manipulated by hand via said gripping area. The massage device 1 is therefore preferentially manual and advantageously intended for home use by a user with no specific professional massage skills. Preferentially, the massage device 1 is designed for the user to use the device 1 on him or herself, that is, on his or her own skin. However, it is perfectly conceivable that the device 1 could be designed for use by the user on the skin of a third party, without departing from the scope of the invention.

Preferentially, the massage head 2 is intended to mechanically massage the skin, particularly the face, namely, to knead the latter in order to provide a generally beneficial effect to the user, such as relaxing him or her, a firming effect on the skin thus “tightened” by the mechanical massage provided, an anti-aging effect, particularly by reducing wrinkles and dark circles, etc. In particular, the massage head 2 helps firm up the muscle fibers in order to counteract the natural sagging of the face (due to cell aging and gravity). The design of the massage head 2 of the device 1 is therefore preferentially well suited, in particular due to its dimensions, to massaging small areas of the body, and in particular to facial massage. More specifically, according to a preferred embodiment, the massage head 2 is intended for massaging a human user's own face.

Preferably, and according to the embodiments shown in the figures, the massage device 1 forms an electrically actuated object to produce a mechanical work, so as to enable a user to massage an area of his or her skin by applying said massage head 2 to it.

Said massage head 2 is advantageously intended to form one of (two) (opposite) ends of the massage device 1, the latter in particular having a substantially elongated shape, and, for example, as shown in FIGS. 1 to 4, a substantially cylindrical overall shape, the massage head 2 then forming an end portion of the cylindrical shape.

Advantageously, in particular when the massage device 1 is positioned vertically as shown in FIGS. 1, 2, 4 and 7, the massage device 1 has a lower end 4 and an upper end 5 opposite the lower end 4. The upper end 5 is preferably formed by said massage head 2. The lower end 4 of the device 1 is preferably part of the main body 3, and may comprise an electrical receiving means (such as a power socket) for receiving a power supply means (such as a power plug), for supplying said main body 3 with electricity, so as to produce, at the massage head 2, a mechanical work allowing the massage.

More specifically, as can be seen in FIGS. 1 to 3, the lower end 4 is designed to be removably connected (either detachable or temporary) with a base 30. Specifically, the lower end 4 is designed to be inserted into said base 30. The latter is preferably designed to provide a dual function: on one hand, keeping the massage device 1 in a stable vertical (or slightly oblique) position, and on the other hand, charging the power, in this case electric, of the device. To this end, the base 30 comprises the power plug designed to cooperate with the power socket on the main body 3. Optionally, it can be considered that the massage device 1 comprises said base 30.

In a known manner, according to the embodiments shown in the figures and in particular in FIG. 2, said massage head 2 is preferentially designed and configured to be connected to said main body 3 in a removable (or temporary) manner. Said main body 3 preferably has a substantially elongated shape with two opposite ends 4, 6. The massage head 2 is preferentially designed to be removably attached at one of the two ends 4, 6 of the main body 3. The massage head 2 is advantageously attached to the main body 3 substantially in the extension thereof. Said main body 3 has, for example, a substantially cylindrical overall shape. For example, one of the two opposite ends of the main body 3 is formed by said lower end 4, while the other end of said main body 3 is formed by a connecting end 6, which is intended to be joined to the massage head 2.

Thus, advantageously, the massage head 2 comprises a first fastening means, and the main body 3 comprises a second fastening means complementary to the first fastening means. For example, the second fastening means is positioned substantially at or near said connecting end 6. Said first and second fastening means are preferably designed to mechanically cooperate in order to reversibly join said massage head 2 and said main body 3. Such fastening means are known as such and will not be detailed further here.

In particular, the massage device 1 is portable, meaning that it is, for example, designed to be operated with only one of the user's hands, with no need for any other mechanical support, and/or that it can be easily carried from one place to another by the user without any particular assistance or vehicle.

For example, the massage device 1 has a size and weight that is small enough to be stored in a bathroom drawer or carried in a backpack or even a handbag.

According to the invention, the massage head 2 comprises at least one working head 7, which comprises massage means 8 that each have a working surface 9 (respective) intended to come into contact with the skin to massage it. For example, as shown in the figures, each massage means 8 has, in particular at the level of its working surface 9, an outer aspect of a half-sphere intended to be rotated when it is brought into contact with the skin in order to massage it.

The said massage means 8 are preferably separate and positioned at a distance from each other. They may also be substantially similar in form and function. The working head 7 comprises, in the embodiments shown in the figures, three massage means 8 (one of them is hidden in FIG. 9), but it could alternatively have only two, or more than three, for example four or five. Nevertheless, the presence of three massage means 8 offers the best compromise between massage efficiency, cost and construction complexity. The working surface 9 of each massage means 8 is preferentially formed by the outer surface of said massage means 8, that is, for example, a surface exposed to the open air and not incorporated/hidden within the rest of the massage head 2. In particular, the working head 7 is shown surrounded by virtual dashes in FIG. 9.

Also according to the invention, the massage head 2 further comprises at least one actuating element 10 designed and configured to rotate said working head 7 around a primary rotation axis X. Said working head 7 is advantageously rotated relative to said main body 3, according to the primary rotation axis X, and is intended to be rotated by said actuating element 10. In FIG. 1, the primary rotation axis X is substantially inscribed in the sectional plane A-A. By convention, the primary rotation axis X is shown, in particular in the figures except for FIG. 3, as vertical, but it may of course have any possible orientation necessary for massaging the user's skin, and in particular for massaging the skin of the user's face. Thus, in the foregoing and in the following, by convention and to simplify the description, the massage device 1 is considered to be positioned vertically, with the massage head 2 at the top (and thus facing upwards), the primary rotation axis X therefore being vertical as previously described, but the device 1 and the massage head 2 may of course have any possible orientation necessary for massaging the user's skin, and in particular for massaging the skin of the user's face. The height or the elevation of an element is preferably considered according to the aforementioned convention.

Advantageously, said working head 7 comprises all the elements of the massage head 2 designed and configured to be rotated, with respect to at least said main body 3, according to said primary rotation axis X. The latter advantageously defines a longitudinal direction of the massage device 1 and/or of the main body 3. The main body 3 thus advantageously has a longitudinal extension direction that is preferably coincident with the primary rotation axis X (or at least parallel to the latter).

In a known manner, the main body 3 comprises, for example, an output shaft 11 and an electric motor 16 driving said output shaft 11. The output shaft 11 is designed to be rotated, for example, according to the primary rotation axis X. The actuating element 10 comprises, for example, at least one actuating shaft 12 comprising a housing 13 for receiving the output shaft 11, thus enabling said working head 7 to be rotated around said primary rotation axis X as indicated above, when the massage head 2 is attached, removably or not, to said main body 3. The main body 3 may comprise, to power the motor, an electric battery and/or the electric receiving means mentioned above. The optional electric battery makes it possible to confer a certain autonomy to the massage device 1 (thus improving its portable feature), and can for example be designed to be recharged with electricity by the aforementioned power supply means, via said base 30.

Said working head 7 preferentially extends substantially around a portion of said primary rotation axis X. Rotating said working head 7 (that is, its rotary actuation by said electric motor) causes it, in substance, advantageously to rotate on itself along the primary rotation axis X, so as to rotate the massage means 8 around the primary rotation axis X.

Preferentially, said working head 7 comprises at least one support assembly 14 incorporating said massage means 8. Advantageously, either said support assembly 14 is attached to the actuating shaft 12, or the actuating shaft 12 is part of said support assembly 14. As described previously with the working head 7, said actuating element 10 is preferably designed and configured to rotate said support assembly 14.

The aforementioned rotary actuation of the working head 7 (including the support assembly 14) preferentially involves an “active” rotation of the working head 7, that is, the production of an automatic mechanical work for massaging the skin, in particular the face. This automatic work is therefore advantageously produced using a motor actuation and not in a “passive” manner such as a back-and-forth movement carried out manually by the user.

According to the invention, the working head 7 is configured so that each massage means 8 can be rotated around a respective secondary rotation axis Y, Y′, Y″ rotation axis. Thus, each massage means 8 extends advantageously around a portion of the secondary rotation axis Y, Y′, Y″ in question and is designed to be rotated around this axis. Rotating the massage means 8 (that is, its rotary actuation, for example by the electric motor) causes it, in substance, to advantageously rotate on itself according to the rotation axis Y, Y′, Y′″ in question. The rotary actuation of each massage means 8 mentioned above involves an “active” rotation of the working means 8, similar to what has been described above for the working head 7. Rotary actuation thus involves an active, constrained, commanded or controlled rotation, as opposed to a passive or free rotation (this is valid both for the working head 7 according to the primary rotation axis X and for the massage means 8 according to their secondary rotation axes Y, Y′, Y″). Advantageously, each massage means 8 comprises at least, for example at its working surface 9, a respective substantially convex portion intended to come into contact with the skin. Said substantially convex portion has, for example, a half-sphere shape as mentioned above. Each substantially convex portion is therefore preferably intended to be rotated according to its respective Y, Y′, Y″ rotation axis. Thus, particularly advantageously, the massage head 2 further comprises actuating means 15 suitable for rotating each massage means 8 according to the respective secondary rotation axis Y, Y′, Y″ (preferably as mentioned above). Said secondary axes of rotation Y, Y′, Y″ are preferably substantially parallel and not coincident.

Each secondary rotation axis Y, Y′, Y″ is preferentially substantially parallel to said primary rotation axis X. Each secondary rotation axis Y, Y′, Y″ is moreover advantageously located at a distance from said primary rotation axis X, and is therefore in particular not coincident with the latter. The actuating means 15 may optionally be suitable for cooperating with the actuating member 10 so as to transmit and transform the rotary movement of the electric motor 16 into a rotary movement of the massage means 8, for example using a gear train.

The actuating means 15 are preferably suitable for ensuring movement to the (for example, three) massage means 8, that is, a secondary rotary movement of the massage means 8 each around its respective secondary rotation axis Y, Y′, Y″. In other words, each massage medium 8 rotates advantageously on itself according to its respective secondary rotation axis Y, Y′, Y″. This secondary rotary movement of the massage means 8 is advantageously a connected movement, meaning that all of the massage means 8 rotate together, and preferentially at the same speed (each around its respective secondary rotation axis Y, Y′, Y″).

Thus, the massage head 2 is preferably suitable for conferring a planetary movement to the (for example, three) massage means 8, that is, a primary rotary movement of the massage means 8 around the primary rotation axis X associated with a secondary rotary movement of each of the massage means 8 around the secondary rotation axis Y, Y′, Y″ in question. Such a planetary movement makes it possible, in particular, to reproduce the kneading or shearing gesture that a professional masseur might make with his fingers. Such a gesture (and therefore movement of the massage means 8) is particularly well suited to treat the cheekbones, cheeks, the oval of the face (the area between the jaws, the chin), or the neck. To this end, said actuating means 15 are advantageously designed to rotate (secondary rotation, therefore) the massage means 8 according to the secondary rotation axes Y, Y′, Y″ relative to the support assembly 14, which preferably only rotates (primary rotation, therefore) according to the primary rotation axis X, in particular by said actuating element 10. Of course, the actuating means 15 are advantageously part of the working head 7, and can be carried by the support assembly 14. The main rotary movement (along the primary rotation axis X) of the massage means 8 is advantageously a connected movement, meaning that all the massage means 8 rotate together, and preferentially at the same speed (around the primary rotation axis X).

According to the invention, said working head 7 further comprises an outer surface 17 from which each massage means 8 emerges. In addition, each massage means 8 rises, from said outer surface 17, to a respective massage height H comprised between 5 mm and 9 mm. In other words, preferentially, the working surface 9 of each massage means 8 extends, from the outer surface 17, over said massage height H which is at least equal to 5 mm, and at most equal to 9 mm. Advantageously, each massage height H is comprised between 6 and 8 mm, for example approximately equal to 7 mm (+/−0.3 mm). For example, each massage height H can be defined as the shortest distance between a point of the outer surface 17 and a point at the same height as the massage means 8 in question, said points being projected on a common axis, preferentially on the primary rotation axis X. For example, the massage height H is measured in a direction parallel to the primary rotation axis X. Thus, the massage height H is on one hand large enough to allow the skin to be massaged, and therefore slightly distorted, by massage means 8, and on the other hand small enough to limit or eliminate the risk of pinching the skin thus massaged. In other words, the massage height H as defined by the invention is a remarkable compromise between the effectiveness of the massage and the lack of pain for the user. Preferentially, the massage heights H of the different massage means 8 are, of course, measured in the vicinity of the latter. Since the outer surface 17 is part of the working head 7, it is preferably designed so that said outer surface 17 is rotated according to the primary rotation axis X by said actuating element 10.

As shown in FIGS. 5 to 7 and 9, said massage means 8 are advantageously positioned substantially below a distal plane D substantially perpendicular to said primary rotation axis X (and, in the embodiments shown, are also perpendicular to each of the secondary rotation axes Y, Y′, Y″). For example, the working surface 9 of each massage means 8 extends from the outer surface 17 to at least one respective free end point 18, the latter preferably being substantially opposite the outer surface 17 relative to the rest of the working surface 9. Said free end point 18 is preferably the point of the massage surface 9 that is most recessed from the outer surface 17, that is, the highest point of the massage means 8. There may optionally be several free end points 18 at the same height (which is preferentially, as we will see, the massage height H). For example, the massage height H may be defined as the distance between a point of the outer surface 17 and the free end point 18, said points being projected on a common axis, preferentially on the primary rotation axis X. Said massage means 8 therefore emerges from said outer surface 17 up to said free end point 18. Preferably, as shown in the figures, (all) said free end points 18 fall within the (same) distal plane D, said massage means 8 advantageously having substantially similar massage heights H. Alternatively, the highest free end point 18, meaning in particular the free end point 18 furthest from the outer surface 17 or highest in a direction parallel to the primary rotation axis X, is inscribed in said distal plane D, and the other free end points 18 are positioned below said distal plane D. The massage means 8 that comprises the highest free end point 18 is preferably the largest of the massage means 8 and/or the one with the highest massage height H. The said massage means 8 are therefore all substantially below said distal plane D, with the optional exception of the free end point 18 of at least one massage means 8, said free end point 18 being inscribed in said distal plane D. Each free end point 18 is preferentially intended to be turned towards the skin, then to come into contact with the skin when said massage head 2 is used. Said massage height H may, for example, be more precisely defined as the distance, measured perpendicular to said distal plane D, between (a point of) the outer surface 17 and the distal plane D. The massage height H may therefore vary substantially over the entire outer surface 17, particularly if the latter is not flat, as will be explained in detail later. The massage height H is preferentially comprised between 5 mm and 9 mm regardless of the point of the outer surface 17 in question. Advantageously, the working surface 9 of each massage means 8 extends protruding from the outer surface 17 to the free end point 18 of said massage means 8.

Preferably, said working head 7 comprises an attached monolithic plate 19 forming said outer surface 17. This monolithic plate 19 is shown in the figures, and a particular embodiment of this plate 19 is shown alone in FIG. 8. Advantageously, said plate 19 is carried by said support assembly 14. Thus, said massage head 2 is preferably designed so that said plate 19 is rotated according to the primary rotation axis X by said actuating element 10. Advantageously, as shown in FIGS. 1 to 7 and 9 in particular, the massage means 8 pass through said monolithic plate 19. Said massage means 8 are therefore preferentially rotated, each according to its respective secondary rotation axis Y, Y′, Y″, relative to the monolithic plate 19. The latter advantageously forms a part attached to one end of the massage head 2 making it possible to significantly decrease, or even eliminate, the risk of unusual or even painful pinching of the skin being massaged by said massage head 2 by filling any gaps that are too large in which skin folds could be lodged. The monolithic plate 19 also makes it easier to modulate the massage height H, which can of course vary over the extent of said plate 19. The monolithic plate 19 is therefore preferentially intended to have a first face facing and preferably in contact with the skin to be massaged, as well as a second face opposite the first face and facing, for example, the working head 7, the support assembly 14 and/or the main body 3. Said first face advantageously forms said outer surface 17. The plate 19 is monolithic, and is therefore advantageously made of a single substantially rigid piece, with a certain cohesion, and which preferably cannot be divided into several parts in normal use, said plate 19 therefore being advantageously not dismantlable into several distinct parts. Alternatively, the monolithic plate 19 is made of several pieces that are joined together so as to obtain a rigid final piece, which has a cohesion, a strength similar or almost similar to that of a single piece. The monolithic plate 19 is preferably made of plastic or metal. It is, according to a particular example, molded from a single block. According to another particular example, the monolithic plate 19 may be formed by several (particularly two) plastic or metal parts welded together.

Said outer surface 17 has, according to a particular embodiment shown in the figures, a globally circular shape, which advantageously has a diameter comprised between 30 mm and 60 mm, preferably between 35 mm and 55 mm, for example approximately equal to 44 mm (+/−3 mm), the size of this diameter being particularly suitable for massaging facial skin. Thus, said monolithic plate 19 has, according to the same particular embodiment shown in the figures, a globally circular shape, which comprises in particular a disk, forming in substance said outer surface 17, and optionally an insertion portion 20 extending substantially in protrusion of said disk opposite the outer surface 17 and intended to be inserted into other elements of said massage head 2. The insertion portion therefore extends advantageously downwards from said second face. For example, the insertion portion 20 extends parallel to the primary rotation axis X and/or perpendicular to said disk. It is preferably designed to secure said monolithic plate 19 to the rest of the working head 7. The disk advantageously has an overall flat appearance, although it may have one or more slight bends, concavity(ies) and/or convexity(ies), with a large bend radius, for example comprised between 100 mm and 250 mm. For example, the disk is unambiguously different from a sphere portion.

Said monolithic plate 19 advantageously has a plurality of through-holes 21. Preferentially, said monolithic plate 19 comprises as many through-holes 21 as massage means 8. Each through-hole 21 is designed to allow one of the massage means 8 to pass through said plate 19 and thus rise above said outer surface 17. Said massage means 8 therefore rise higher than the outer surface 17, but preferably not plumb to the latter. Said through-holes 21 are preferentially made in said disk. Advantageously, the massage means 8 and the outer surface 17 (or more specifically the monolithic plate 19) are not joined together, and there is a very small gap (less than 2 mm, preferably comprised between 0.2 mm and 1.2 mm), perpendicular to said primary rotation axis X or to said secondary rotation axis Y, Y′, Y″ in question, between each massage means 8 and the outer surface 17 (or more specifically the monolithic plate 19). Preferably, the massage head 2 is designed so that this gap is provided between each massage means 8 and an inner edge 22 of the through-hole 21 into which said massage means 8 is inserted. This gap makes it possible, in particular, by massage means 8, to be rotated according to its respective secondary rotation axis Y, Y′, Y″, but is small enough to avoid unwanted pinching of the skin.

Each massage means 8 preferably has a dimension (also known as the maximum dimension M, shown in FIG. 6) measured perpendicular to the secondary rotation axis Y, Y′, Y″ of the massage means 8, said dimension (maximum M) being comprised between 7 mm and 12 mm, more preferentially comprised between 8 mm and 11 mm, for example equal to about 9.5 mm (+/−0.5 mm). This dimension (maximum M) is, for example, measured where the massage means 8 emerges from the outer surface 17, that is, advantageously the lowest (visible) elevation of said massage means 8. Said dimension (maximal M) is, for example, a diameter, and in particular a diameter of a substantially cylindrical portion of the massage means 8, or a diameter of a base of a frustoconical portion of the massage means 8. Thus, each through-hole 21 advantageously has a diameter that is complementary to the shape of the massage means 8 (in particular its maximum dimension M) inserted in said through-hole 21, said complementary diameter being preferably comprised between 7.5 mm and 12.5 mm, more preferentially comprised between 8.5 mm and 11.5 mm, for example equal to about 10 mm (+/−0.5 mm).

Preferably, said outer surface 17 comprises, between said massage means 8, a first surface portion 23. Said first surface portion 23 is preferentially positioned at a distance (optionally referred to as the first massage distance M₁) comprised between 5 mm and 9 mm of said distal plane D, more preferentially comprised between 6 mm and 8 mm. Said distance (massage distance M₁) is preferentially calculated in a direction parallel to said primary rotation axis X. Thus, the distance defined above, optionally referred to as the first massage distance M₁, is advantageously, at said first surface portion 23, said massage height H. Preferentially, said first surface portion 23 extends substantially between said massage means 8, and is, for example, the outer surface part 17 highlighted between (virtual) dashes in FIGS. 3 and 8. The specific position of the first surface portion 23 makes it possible in particular to avoid excessive and/or painful pinching of the massaged skin between said massage means 8, while ensuring good massage efficiency, since the skin may be pulled in between said massage means 8 but in a limited manner (and in particular only at the first massage distance M₁ comprised between 5 mm and 9 mm). In other words, due to the first massage distance M₁, the risk of painful pinching of the skin between several massage means 8 is drastically reduced or even eliminated, which in particular makes it possible to use the massage head 2 to massage any type of skin (meaning, in particular the skin of anyone's face, or any area of the face, whether the skin is sagging, thin, firm, supple, etc.).

Particularly advantageously, between two massage means 8, said first surface portion 23 has at least one respective line portion (referred to as an interval line) that is the shortest possible, each point of said shortest possible line portion (interval line) being positioned at a distance comprised between 5 mm and 9 mm from said distal plane D, and more preferentially comprised between 6 mm and 8 mm, said distance constituting in substance said first massage distance M₁. Thus, “the shortest possible expression” refers to the shortest straight line distance L that separates the first surface portion 23 from the plane D. Said interval line is for example shown by the line of the first surface 23 located below (according to a direction parallel to the primary rotation axis X) the dashes showing the interval distance identified as N in FIG. 3, and can therefore be substantially curved (see concavity described below).

According to a preferential exemplary embodiment, when the working head 7 comprises three massage means 8, the latter are advantageously arranged so as to form (globally) the vertices of a (virtual) equilateral triangle, as shown in the figures, and the first surface portion 23 has an overall triangular shape with rounded edges, as highlighted by dashes in FIGS. 3 and 8. Thus, if the working head 7 comprises three massage means 8, they each advantageously comprise at least one respective free end point 18 as mentioned above, and said three free end points 18 are preferably arranged so as to form the vertices of a (virtual) equilateral triangle. The equilateral triangle preferentially comprises a (virtual) center through which said primary rotation axis X passes.

Preferably, the massage head 2 comprises a bearing ring 25 intended to contact the skin and defining, on one hand, a bearing surface 26 inscribed within a bearing plane P and, on the other hand, a work area Z located inside the bearing ring 25 and in which said outer surface 17 is located, at least a portion of the working surface 9 of each massage means 8 extending protruding from the bearing plane P. Particularly advantageously, said bearing ring 25 is separate from said working head 7 so that when the latter is rotated by said actuating element 10, said bearing ring 25 remains fixed. Thus, when using said massage head 2 (and therefore the device 1), that is, when actuating the working head 7 to massage the skin, said bearing ring 25 remains preferentially fixed relative to the main body 3 (notwithstanding the optional removal mentioned above, of the massage head 2 when not in use). Preferentially, the portion of the working surface 9 of each massage medium 8 extending protruding from the bearing plane P is in substance formed by the outer surface of the massage medium 8 comprised between the bearing plane P and the distal plane D, as shown in particular in FIG. 6. This outer surface of the massage medium 8 comprised between said bearing planes P and distal planes D forms in particular a protrusion protruding from the bearing plane 25, from the bearing plane P to the free end point 18. The bearing ring 25 allows the user to better control the skin massage, by resting the bearing surface 26 of the bearing ring 25 on the skin. The bearing ring 25 is preferably fixed and therefore with no electrically actuated rotation, and remains stationary relative to the main body 3, while the working head 7 is rotated. Such a configuration allows a particularly effective and controlled massage of each area of the skin within said work area Z. The work area Z preferably includes the space comprised between the outer surface 17 and the distal plane D. In addition, the bearing ring 25 makes it possible to avoid an inadvertent movement of the massage head 2 along the skin of the user. This inadvertent movement may be caused on one hand by the rotation of the outer surface 17 according to the primary rotation axis X and on the other hand by the movement, advantageously planetary (or in any case rotary), of the massage means 8 (which advantageously perform a primary rotation according to the primary rotation axis X and a secondary rotation according to their respective secondary rotation axes Y, Y′, Y″). For example, the bearing ring 25 generally has a fixed ring shape surrounding the monolithic plate 19, as shown in the figures with the exception of FIGS. 7 and 8. In FIG. 7, the bearing ring 25 and the other fixed elements of the massage head 2 were removed to show only the working head 7 (which rotates around the primary rotation axis X).

Preferably, said outer surface 17 comprises, around said first surface portion 23, a second surface portion 24 positioned at a distance (optionally referred to as the second massage distance M₂) comprised between 5 mm and 9 mm of said distal plane D, more preferentially comprised between 5.5 mm and 7.5 mm. Said distance (massage distance M₂) is preferentially calculated in a direction parallel to said primary rotation axis X. Thus, the distance defined above, optionally known as the second massage distance M₂, is advantageously, at said second surface portion 24, said massage height H. Preferentially, said second surface portion 24 extends substantially around said first surface portion 23, and also advantageously surrounds the plurality of massage means 8. Said second surface portion 24 is, for example, the outer surface portion 17 outside the (virtual) dotted lines in FIGS. 3 and 8. For example, if the working head 7 comprises three massage means 8, as shown in the figures, the second surface portion 24 has an overall ring shape, and more specifically that of a region comprised between a circle (the free outer edge 27 described below) and a triangular-shaped central area with rounded edges (the first surface portion 23). The specific position of said second surface portion 24 makes it possible in particular to avoid excessive and/or painful pinching of the massaged skin between one of the massage means 8 and another element of the massage head 2 such as the bearing ring 25, while ensuring good massage efficiency, since the skin may be pulled in between one of the massage means 8 and the bearing ring 25 but in a limited manner (and in particular only at the second massage distance M₂ comprised between 5 mm and 9 mm). In other words, due to the second massage distance M₂, the risk of painful pinching of the skin between one of the massage means 8 and the bearing ring 25 is drastically reduced or eliminated, which in particular allows the massage head 2 to be used to massage any type of skin. Said first and second surface portions 23, 24 are preferably joined, as extensions of each other, and advantageously made of material, their purely virtual and functional separation being only shown in FIGS. 3 and 8 by virtual dotted lines themselves.

Preferably, the surface of each massage means 8 is located at a distance (optionally known as crown distance C) greater than or equal to 6 mm from said bearing ring 25, said distance (crown distance C) being more preferentially comprised between 7 mm and 12 mm, for example approximately equal to 9.5 mm (+/−0.6 mm). This (crown C) distance is in particular measured in a direction perpendicular to the primary rotation axis X and/or a direction parallel to the bearing plane P. Such a configuration helps avoid painful pinching, while ensuring excellent massage efficiency.

Particularly advantageously, the massage means 8 are evenly arranged, within massage area Z, around the primary rotation axis X. Preferentially, the secondary rotation axes Y, Y′, Y″ are substantially parallel to the primary rotation axis X and are therefore evenly spaced around the X axis. The secondary axes of rotation Y, Y′, Y″ are preferentially all located perpendicular to the primary rotation axis X, at the same distance (not shown) from the primary rotation axis X. This even arrangement allows for excellent distribution of the massage movement over the area of skin to be massaged.

Preferably, between each massage means 8 and said bearing ring 25, said outer surface 17 has at least one respective line portion L (optionally referred to as a lateral) that is the shortest possible, each point of said shortest possible line portion (lateral) L being positioned at a distance of less than or equal to 4 mm, and preferably comprised between 0.4 mm and 1.4 mm, from said bearing plane P, the distance being measured parallel to the primary rotation axis X, that is, vertically as explained above. Thus, “the shortest possible expression” refers to the shortest distance in a straight line L that separates each massage medium 8 and the bearing ring 5, the line L belonging to the outer surface 17. Said line portion (lateral) L is advantageously part of said second surface portion 24, and is shown in particular by a dotted line in FIG. 3. This configuration provides a significant anti-pinching effect on the outer surface 17. More advantageously, said second surface portion 24 is positioned, preferably at all points, at a distance less than or equal to 4 mm, and preferably comprised between 0.4 mm and 1.4 mm, from said bearing plane P, preferably in a direction parallel to the primary rotation axis X. Thus, the risk of an undesirable and painful pinch occurring between the bearing ring 25 and one of the massage means 8 is particularly reduced.

In particular, said outer surface 17 has a substantially circular free outer edge 27. Advantageously, said free outer edge 27 defines the second surface portion 24, the latter therefore extending between said free outer edge 27 and said first surface portion 23. Said free outer edge 27 is preferably surrounded by the bearing ring 25, each portion of the free outer edge 27 facing a portion of the bearing ring 25.

According to a particular embodiment of the invention, said free outer edge 27 is positioned, in a direction parallel to said primary rotation axis X, at a distance (optionally referred to as edge distance B, shown in FIG. 6) less than or equal to 2 mm, and preferably comprised between 0.6 mm and 1.8 mm, from said bearing plane P. Preferentially, said outer surface 17 is positioned, advantageously at all points, in a direction parallel to said primary rotation axis X, at a distance (optionally referred to as a bearing/surface distance E, shown in FIG. 6) less than or equal to 2 mm, and preferably comprised between 0.4 mm and 1.8 mm, from said bearing plane P. Of course, at the free outer edge 27, said distance (bearing/surface distance E) is formed by the edge distance B.

FIG. 6 shows the minimum bearing/surface distance E for the outer surface 17 in question. For example, the bearing/surface distance E and/or the massage height H is/are maximal at the center of the outer surface 17, particularly when the latter has a concave area 28 as described below. At said second surface portion 24, the bearing/surface distance E is, preferably at all points of the second surface portion 24, advantageously comprised between 0.4 mm and 1.4 mm.

According to another particular embodiment of the invention, compatible with the previous one, said free outer edge 27 defines, perpendicular to said primary rotation axis X, a clearance J with said bearing ring 25 that is less than or equal to 2 mm, preferably comprised between 0.2 mm and 1.2 mm. The clearance J is advantageously measured according to a distance substantially parallel to said bearing plane P. In other words, advantageously, said outer surface 17 is positioned at a certain distance, represented by clearance J, from said bearing ring 25, said distance (that is, said clearance J) being less than or equal to 2 mm, preferably comprised between 0.2 mm and 1.2 mm, and measured horizontally when the primary rotation axis X is vertical. Such a configuration, shown in the figures and in particular in FIGS. 6 and 9, makes it possible to prevent the skin from becoming trapped between the bearing ring 25 and the outer surface 17, and thus greatly reduces, or even eliminates, the risk of painful pinching. Edge distance B (or bearing/surface distance E) and clearance J both prevent unwanted skin pinching and allow for proper skin massage. Clearance J is preferentially found all around the free outer edge 27.

Advantageously, the shortest distance (optionally referred to as interval distance N, shown in FIGS. 3 and 5) between the surface of two massage means 8 is comprised between 5 mm and 7.8 mm, preferably about 7 mm (+/−0.3 mm). Such a configuration is also optimal to avoid painful pinching of the massaged skin between the massage means 8 while still effectively massaging the skin (meaning that enough skin is allowed to “get in” between said massage means 8).

Preferably, the outer surface 17 comprises a concave area 28 having an outwardly facing concavity, that is, advantageously the concavity is intended to be turned towards the skin while it is being massaged. More advantageously, the concavity is intended to be at least partly in contact with the skin while it is being massaged. Preferentially, at least one (and advantageously all) of the massage means 8 is (are) positioned(s) in said concave area 28. Such a configuration is shown in the embodiments in the figures, and makes it possible to optimize massage efficiency. In essence, this configuration makes it possible to substantially increase, by means of a construction detail that can be easily implemented on the outer surface 17 and/or the monolithic plate 19, the amount of skin that can be “pulled in” within the work area Z, compared to an outer surface that would be flat or only convex. In the embodiments shown in FIGS. 1 to 8, the concave area 28 substantially forms a central part of the outer surface 17 (and therefore of the monolithic plate 19). Preferably, said concavity has a bend radius comprised between 100 mm and 250 mm, more preferentially comprised between 140 mm and 200 mm, for example approximately equal to 170 mm (+/−10 mm). As shown in FIGS. 1 to 8, the first surface portion 23 advantageously comprises at least a portion of said concave area 28. For example, said concave area 28 forms the entire said first surface portion 23 and a portion of the second surface portion 24, as shown in FIGS. 1 to 8. The concave area 28 is preferably positioned at least in part between said massage means 8.

Optionally, as shown in FIGS. 1 to 8, the outer surface 17 further comprises a convex lateral area 29, said second surface portion 24 advantageously comprising said convex lateral area 29. For example, said convex lateral area 29 surrounds said concave area 28, and is between said free outer edge 27 and said first surface portion 23, which are therefore at a lower elevation than that of the convex lateral area 29. Such a configuration provides excellent mechanical resistance to the monolithic plate 19, as well as increased or at least preserved massage efficiency, and incidentally some aesthetic appeal to said massage head 2. This configuration also helps to avoid creating an edge that is too pronounced and potentially harmful to the user, for example at the free outer edge 27. Such an edge is in particular visible in FIG. 9, although the embodiment is shown is purely schematic.

Very preferentially, the distal plane D and the bearing plane P are not coincident, and are positioned relative to each other, in a direction parallel to the primary rotation axis X, at a distal/bearing distance U advantageously comprised between 4 mm and 7 mm, more preferentially comprised between 4.5 mm and 6.5 mm. Of course, the distal plane D is preferably above the bearing plane P.

In general, unless there is a potential exception, the referenced elements of the massage head 2 and the massage device 1 have some rigidity, that is, their own mechanical resistance, and can be made of any suitable material (plastic, metal in particular).

In addition to the benefits already listed regarding the anti-pinch feature of the massage head 2, the latter is in particular optimized to ensure excellent hygiene in use. Indeed, due to the features mentioned above, optional or not, the outer surface 17 makes it possible to prevent unwanted elements, such as dirt, from getting in from the outside to the inner mechanism of the massage head 2. These undesirable elements may in particular be, when using the device 1 and the massage head 2, dead skin, dust, cream applied to the skin, or when storing the device 1 and the massage head 2 (thus when not in use), dust, a wire from an electrical device, a portion of a small body care tool (nail clipper, for example), etc. The device 1 and the massage head 2 can thus be used on skin pre-coated with cream to improve massage efficiency. This is especially true for skin that is damaged, thin, ageing, etc. For example, the clearance J makes it possible to significantly reduce the risk of unwanted elements getting in between the bearing ring 25 and the outer surface 17 (more specifically its free outer edge 27), and deteriorating or fouling the working head 7, especially the mechanisms beneath the outer surface 17, such as the actuating means 15 or the actuating element 10, which would reduce the useful life of the device 1 and the massage head 2. For reasons similar to the above, that is, the reduction of the risk of introducing undesirable elements within the working head 7, the maintenance and in particular the cleaning of the massage head 2 are greatly facilitated. The monolithic plate 19, in particular, helps protect the inside of the massage head 2.

According to another aspect that could be an invention in its own right, the invention may relate to a massage head 2 for a mechanical skin massage device 1, said device 1 comprising a main body 3 forming a manual gripping area and to which said massage head 2 is intended to be connected. According to this other aspect, the invention could also relate to a mechanical skin massage device 1, comprising a main body 3 forming a manual gripping area and a massage head 2 intended to be connected to said main body 3, the massage head 2 corresponding to said other aspect of the invention mentioned above, that is, as described in this description and in particular below. The massage head according to this other aspect may comprise all or part of the features described above for the first aspect of the invention. According to this other aspect, the massage head 2 comprises at least:
a working head 7, comprising massage means 8 that each have a working surface 9 intended to come into contact with the skin to massage it, the working head 7 being configured so that each massage means 8 can be rotated around a respective secondary rotation axis Y, Y′, Y″, and
an actuating element 10 designed and configured to rotate said working head 7 around a primary rotation axis X, said working head 7 comprising an outer surface 17 from which each massage means 8 emerges, said working head 7 further comprising an attached monolithic plate 19 forming said outer surface 17, the massage means 8 traversing said monolithic plate 19.

Each area of the body has specific massage challenges. In particular, the face is an area that is extremely sensitive to painful pinching by mechanical massage parts, due in particular to the protruding nature of certain portions of the face (cheekbones, etc.), the amount of skin present in certain areas (cheeks, neck, for example), and the condition of this skin depending on the areas and people massaged. The device 1 and the massage head 2 of the invention are particularly suitable for effectively massaging the skin of the face of a user, particularly a non-professional, without unpleasant or painful pinching, regardless of the user's skin type (for example, regardless of the presence of wrinkles, sagging, thinness, elasticity of the skin).

1. A massage head for a mechanical skin massage device, said device comprising a main body forming a manual gripping area and to which said massage head is intended to be connected, the massage head comprising at least:
a working head, comprising massage means that each have a working surface intended to come into contact with the skin to massage it, the working head being configured so that each massage means can be rotated around a respective secondary rotation axis (Y, Y′, Y″), and
an actuating element designed and configured to rotate said working head around a primary rotation axis (X),
said working head further comprising an outer surface from which each massage means emerges, each massage means { }rising, from said outer surface, to a respective massage height (H) comprised between 5 mm and 9 mm.

2. The massage head according to the preceding claim 1, wherein each massage height (H) is comprised between 6 mm and 8 mm, for example approximately equal to 7 mm (+/−0.3 mm).

3. The massage head according to claim 1, wherein said massage means are positioned below a distal plane (D) substantially perpendicular to said primary rotation axis (X), said outer surface comprising, between said massage means, a first surface portion positioned at a distance comprised between 5 mm and 9 mm from said distal plane (D).

4. The massage head according to the preceding claim 1, wherein said outer surface comprises, around said first surface portion, a second surface portion positioned at a distance comprised between 5 mm and 9 mm from said distal plane (D).

5. The massage head according to any claim 1, wherein it comprises a bearing ring intended to contact the skin and defining, on one hand, a bearing surface inscribe within a bearing plane (P) and, on the other hand, a work area (Z) located inside the bearing ring and in which said outer surface is located, at least a portion of the working surface of each massage means extending protruding from the bearing plane (P), said bearing ring being separate from said working head so that when the latter is rotated by said actuating element, said bearing ring remains fixed.

6. The massage head according to the preceding claim 1, wherein said outer surface has a substantially circular free outer edge positioned, according to a parallel direction to said primary rotation axis (X), at a distance of less than or equal to 2 mm, and preferably comprised between 0.6 mm and 1.8 mm, from said bearing plane (P).

7. The massage head according to claim 5, wherein said outer surface has a substantially circular free outer edge defining, perpendicular to said primary rotation axis (X), a clearance (J) with said bearing ring that is less than or equal to 2 mm, preferably comprised between 0.2 mm and 1.2 mm.

8. The massage head according to claim 5, wherein between each massage means and said bearing ring, said outer surface has at least one respective line portion (L) that is the shortest possible, each point of said shortest possible line portion (L) being positioned at a distance of less than or equal to 4 mm, and preferably comprised between 0.4 mm and 1.4 mm, from said bearing plane (P).

9. The massage head according to claim 1, wherein the shortest distance between the surface of two massage means is comprised between 5 mm and 7.8 mm, preferably about 7 mm (+/−0.3 mm).

10. The massage head according to claim 1, wherein the outer surface comprises a concave area having an outwardly facing concavity, at least one of said massage means being positioned in said concave area.

11. The massage head according to the preceding claim 1, wherein said concavity has a bend radius comprised between 100 mm and 250 mm.

12. The massage head according to claim 1, wherein each massage means comprises at least one respective substantially convex portion intended to come into contact with the skin.

13. The massage head according to claim 1, wherein said working head comprises an attached monolithic plate forming said outer surface, and in that the massage means pass through said monolithic plate.

14. A mechanical skin massage device, comprising a main body forming a manual gripping area and a massage head intended to be connected to said main body, the massage head corresponding to claim 1.

15. The massage device (1) according to claim 14, wherein said massage head is designed and configured to be removably connected to said main body.
